(19) United States
(12) Patent Application Publication
(10) Pub. No.: US 2022/0237552 A1
(43) Pub. Date: Jul. 28, 2022

(54) Product Tracking System And Method

(71) Applicant: William Meehan, Mount Pleasant, SC (US)

(72) Inventor: William Meehan, Mount Pleasant, SC (US)

(21) Appl. No.: 17/584,815

(22) Filed: Jan. 26, 2022

Related U.S. Application Data
(60) Provisional application No. 63/142,782, filed on Jan. 28, 2021.

(51) Int. Cl. G06Q 10/08; G06K 7/10

(52) U.S. Cl. CPC G06Q 10/087; G06K 7/10366

(57) ABSTRACT

A product tracking system and method includes a tracking device having a power supply, a wireless transceiver, and a processor operably connected to a non-transitory computer readable medium. A logic stored in the non-transitory computer readable medium causes the tracking device to perform a method, which includes receiving and storing identification information relating to the current contents of the container; receiving, from a remote device and via the wireless transceiver, a command instruction; and transmitting, in response to the command instruction and via the wireless transceiver, the identification information stored in the non-transitory computer readable medium to the remote device. The identification information can relate to multiple items stored within a container. The tracking device can be embedded or secured within the container and transmit the identification information to an external device, such that the contents of the container can be identified without opening the container.

### CROSS REFERENCE TO RELATED APPLICATIONS

This application claims the benefit of U.S. Provisional Application No. 63/142,782, filed on Jan. 28, 2021. The above identified patent application is herein incorporated by reference in its entirety to provide continuity of disclosure.

### BACKGROUND OF THE INVENTION

The present invention relates to a product tracking system and method. More specifically, the present invention provides a product tracking system and method that utilizes a wireless tracking device that transmits information about container contents to a remote device, such that an individual can determine the contents of the container without needing to open the container.

Warehouses and other similar storage and operations facilities often house many individual containers. The containers may be prepacked with particular items. For example, a shipping warehouse organizes and stores packages that are filled with particular items depending on the customer's order. It is important to identify the contents of the package for organizing and ensuring that the customer receives the correct items. It can be difficult to identify products stored in overhead areas that are out of sight and reach, and it is also not possible to visually verify the contents of the package or container once it has been sealed closed. In a warehouse with overhead bins, it can be time consuming to find a correct storage container when looking for particular items. Numerous items may be stored without identifying markings on the items themselves, so it can be difficult to access what is needed in a timely manner.

In the shipping or packaging field, one way to identify container contents is to include a physical packing slip or manifest within the container. However, the container must then be opened to inspect the packing slip. Once the package is packed with the items and packing slip, it typically cannot and should not be opened until the customer receives the container. If the packing slip must be checked prior to sending to the customer, the items will usually need to be repackaged. Additionally, many containers in the warehouse setting are stored high on stacked shelving, which makes them difficult to access for physical inspection. Some containers may have scannable exterior barcodes that relate to information stored in a database regarding the container contents, but these must still be accessed by a physical reader, which may be unsafe or impossible given the position of the container. Time and effort must be made to safely retrieve the container for scanning. It is therefore desirable to provide an improved system and method for identifying particular contents of a container, without having to physical open or inspect the container itself.

In light of the systems and methods in the known art, it is submitted that the present invention substantially diverges in design elements from the known art and consequently it is clear that there is a need in the art for an improvement to existing facemasks and similar devices. In this regard the present invention substantially fulfills these needs.

### SUMMARY OF THE INVENTION

The present invention provides a product tracking system and method wherein the same can be utilized for monitoring the location of individual products and groupings of products without having to open a container in which they are stored. The product tracking system and method generally includes a tracking device disposed within a container. The tracking device includes a power supply, a wireless transceiver, and a processor operably connected to a non-transitory computer readable medium. A logic stored in the non-transitory computer readable medium, when executed by the processor, causes the tracking device to perform a method. The method includes the steps of receiving and storing identification information relating to the current contents of the container; receiving, from a remote device and via the wireless transceiver, a command instruction; and transmitting, in response to the command instruction and via the wireless transceiver, the identification information stored in the non-transitory computer readable medium to the remote device. In this way, the product tracking system and method can track individual containers and verify the contents of said containers.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout. The dimensions and shapes of the items illustrated are intended to be for example purposes only and should not be considering limiting in any respect.

FIG. 1 shows a perspective view of the tracking device from an embodiment of the product tracking system and method.

FIG. 2 shows a perspective view of the tracking device and external computing device from an embodiment of the product tracking system and method.

FIG. 3 shows a perspective view of an embodiment of the product tracking system and method in use within a warehouse environment.

FIG. 4 shows a block diagram of the components from an embodiment of the product tracking system and method.

### DETAILED DESCRIPTION OF THE INVENTION

According to some embodiments, the operations, techniques, and/or components described herein can be implemented as (i) a special-purpose computing device having specialized hardware and a logic hardwired into the computing device to persistently perform the disclosed operations and/or techniques or (ii) a logic that is implementable on an electronic device having a general purpose hardware processor to execute the logic and a computer-readable medium, e.g. a memory, wherein implementation of the logic by the processor on the electronic device provides the electronic device with the function of a special-purpose computing device.

In the interests of economy, the present disclosure refers to “a computer-readable medium,” “a processor,” and so on. However, this should not be read as limiting in any way as the present disclosure contemplates embodiments of the present invention utilizing “one or more computer-readable media,” “one or more processors,” and so on. Unless specifically limited to a single unit, “a” is intended to be equivalent to “one or more” throughout the present disclosure.

According to some embodiments, the operations, techniques, and/or components described herein can be implemented by an electronic device, which can include one or more special-purpose computing devices. The special-purpose computing devices can be hard-wired to perform the operations, techniques, and/or components described herein, or can include digital electronic devices such as one or more application-specific integrated circuits (ASICs) or field programmable gate arrays (FPGAs) that are persistently programmed to perform the operations, techniques and/or components described herein, or can include one or more general purpose hardware processors programmed to perform such features of the present disclosure pursuant to program instructions in firmware, memory, other storage, or a combination. Such special-purpose computing devices can also combine custom hard-wired logic, ASICs, or FPGAs with custom programming to accomplish the technique and other features of the present disclosure. The special-purpose computing devices can be desktop computer systems, portable computer systems, handheld devices, networking devices, or any other device that incorporates hard-wired and/or program logic to implement the techniques and other features of the present disclosure.

Reference is made herein to the attached drawings. Like reference numerals are used throughout the drawings to depict like or similar elements of the product tracking system and method. For the purposes of presenting a brief and clear description of the present invention, a preferred embodiment will be discussed as used for providing a product tracking system and method that allows individuals to monitor and verify the location of particular items within different containers without having to open the containers to inspect their contents. The figures are intended for representative purposes only and should not be considered to be limiting in any respect.

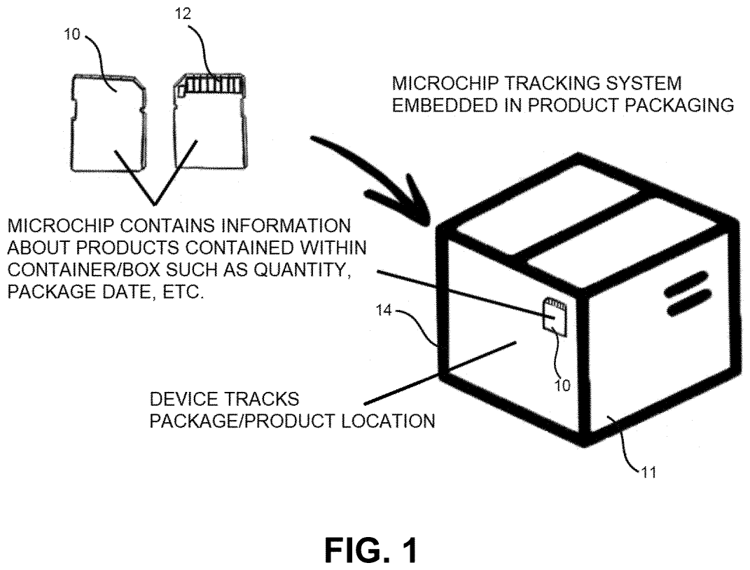

Referring now to FIG. 1, there is shown a perspective view of the tracking device from an embodiment of the product tracking system and method. The product tracking system includes a tracking device 10 that is disposed within a container 11. The system can utilize any number of unique tracking devices 10 as needed. The tracking devices 10 preferably include a housing which stores a power supply, a wireless transceiver, and a processor operably connected to a non-transitory computer readable medium, such as a solid-state memory device, as one example. The power supply may be a rechargeable battery. In some embodiments, the tracking device 10 includes an external electrical contact 12 that is in electrical communication with the power supply and with the non-transitory computer readable medium. This allows the electrical contact 12 to charge the power supply when connected to an external power source. Further, the electrical contact 12 can also receive identifying information and other product information via a physical connection to an external data source. The tracking device 10 can also receive updated container content information wirelessly via the wireless transceiver.

In some embodiments, the tracking device 10 may be removably disposed within the container 11. This allows the tracking device 10 to be reused with different containers 11. The tracking device 10 may include a fastener such as a magnet, an adhesive material, or the like, in order to secure the tracking device 10 within the container 11. In other embodiments, the tracking device 10 is embedded within a sidewall 14 or other portion of the container 11. This prevents tampering with the tracking device 10, as the container 11 would have to be visibly altered or damaged to access the tracking device 10. In this way, the tracking device 10 can deter tampering or theft of the container contents.

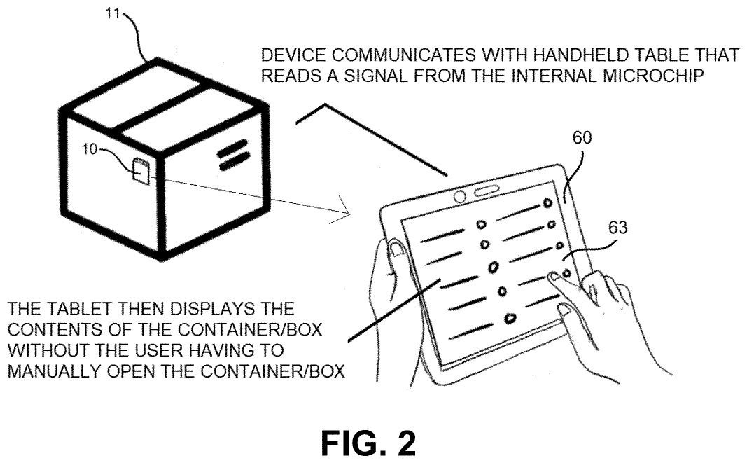

Referring now to FIG. 2, there is shown a perspective view of the tracking device and external computing device from an embodiment of the product tracking system and method. The tracking device 10 stores identification information relating to the contents of the container 11. For example, the identification information can include the number of items and names or descriptions of the individual items in the container. In some embodiments, the identification information further includes a packaging date. In other embodiments, the identification information further includes a unique tracking device identifier that corresponds to a unique identifier assigned to the container in which the tracking device is disposed. Additional information may be stored in order to assist individuals with locating and classifying different containers based on their contents. For example, a precise location of the container within a store or warehouse can be included, so that the tracking device 10 can transmit its location when accessed, and the container can easily be located.

After receiving and storing identification information relating to the current contents of the container, a remote device 60 can be utilized to send and receive information to and from the tracking device 10. The remote device 60 can be a handheld tablet as shown, or may be some other type of electronic terminal having at least a display, input controls, and a wireless transceiver for sending and receiving information remotely. In operation, the tracking device 10 receives a command instruction from the remote device 60 and via the wireless transceiver, which may include a request for the identification information stored in the tracking device 10. In response to the command instruction and via the wireless transceiver, tracking device 10 transmits its identification information to the remote device 60, so that the contents of the container, the container location, and other information can be viewed on the display 63 of the remote device 60.

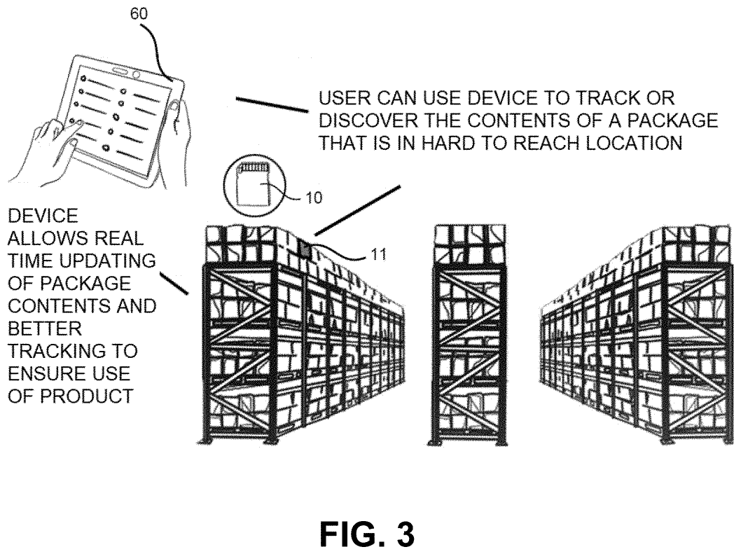

Referring now to FIG. 3, there is shown a perspective view an embodiment of the product tracking system and method in use within a warehouse environment. In such settings, the container 11 may be stored high on a shelf, behind other containers, or otherwise in a difficult to access position. The user may utilize the handheld device 60 to request tracking information from a particular container. The tracking device 10 then transmits its information to the handheld device. This can also assist individuals in tracking the location of individual containers 11 within the warehouse. For example, individuals may need to pull particular items from particular storage containers 11. The system can locate the container, display the container contents, and be updated as the container contents change, so that the user can keep constant track of the container location and its items.

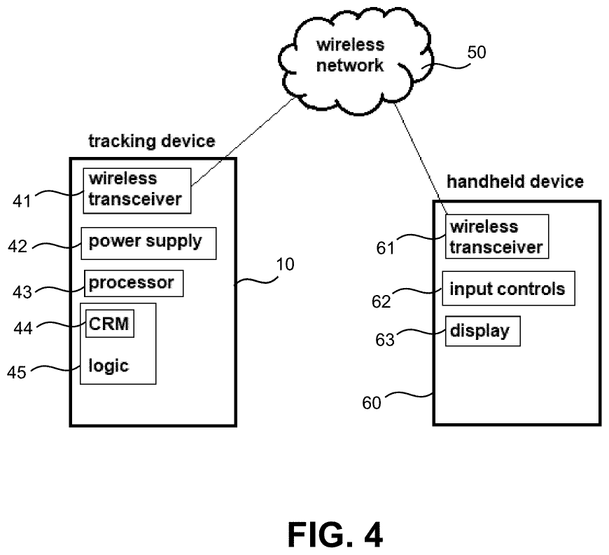

Referring now to FIG. 4, there is shown a block diagram of the components from an embodiment of the product tracking system and method. The tracking device 10 includes at least a wireless transceiver 41, a power supply 42, a processor 43, a computer readable medium 44, and a logic 45 that dictates the operation of the system. The handheld device 60, which includes at least its own wireless transceiver 61, input controls 62, and display 63, is in wireless communication with the tracking device 10 via a wireless network 50. The wireless network 50 may be an internet connection, a WLAN connection, a Bluetooth connection, or any other commonly utilized wireless communication network protocols. The wireless communication allows the tracking device 10 to be accessed from any location, without having to physically inspect the container in which it is installed.

The identification information of the tracking device 10 can be updated in real time if needed via the handheld or external device 60. For example, if an individual does remove items from a container, the individual can update the tracking device 10 identification information via the handheld device 60 so that the item totals and descriptions are accurate after items have been removed. In other uses, such as in consumer product packaging, the tracking device 10 identification information is fixed, so that any removal of an item will be detected. In this way, the system and method for tracking products can be utilized in a variety of settings to determine and verify package contents.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, and all equivalent relationships to those illustrated in the drawings and described in the specification are intended to be encompassed by the present invention. Therefore, the foregoing is considered as illustrative only of the principles of the invention. Further, it is not desired to limit the invention to the exact construction and operation shown and described, and accordingly, all suitable modifications and equivalents may be resorted to, falling within the scope of the invention.

I claim:

1) A product tracking system and method, comprising:
a tracking device disposed within a container, the tracking device comprising a power supply, a wireless transceiver, and a processor operably connected to a non-transitory computer readable medium;
a logic stored in the non-transitory computer readable medium that, when executed by the processor, causes the tracking device to perform a method, the method comprising:
receiving and storing identification information relating to the current contents of the container;
receiving, from a remote device and via the wireless transceiver, a command instruction; and
transmitting, in response to the command instruction and via the wireless transceiver, the identification information stored in the non-transitory computer readable medium to the remote device.

2) The product tracking system and method of claim 1, wherein the identification information comprises a listing of individual items that are stored within the container.

3) The product tracking system and method of claim 2, wherein the identification information further comprises a packaging date.

4) The product tracking system and method of claim 2, wherein the identification information further comprises a unique tracking device identifier that corresponds to a unique identifier assigned to the container in which the tracking device is disposed.

5) The product tracking system and method of claim 1, wherein the power supply comprises a rechargeable battery.

6) The product tracking system and method of claim 1, wherein the tracking device is removable from its position within the container.

7) The product tracking system and method of claim 6, wherein the tracking device comprises a fastener configured to secure the tracking device to the container.

8) The product tracking system and method of claim 1, wherein the tracking device comprises electrical contacts on an exterior thereof, such that information can be transferred to the tracking device via a hardwired connection with an external computing device.

9) The product tracking system and method of claim 1, wherein the container is a package that holds individual products.

10) The product tracking system and method of claim 1, wherein the container holds multiple packages, wherein each package holds individual products.

11) The product tracking system and method of claim 10, wherein the container is a shipping container.

12) The product tracking system and method of claim 10, wherein the container is a storage area for the multiple packages.

13) The product tracking system and method of claim 9, wherein the tracking device is embedded within a sidewall of the container.
